(19) United States
(12) Patent Application Publication
(10) Pub. No.: US 2018/0258784 A1
(43) Pub. Date: Sep. 13, 2018

(54) SEAL CARRIER FOR A TURBOMACHINE

(71) Applicant: MTU Aero Engines AG, Muenchen (DE)

(72) Inventors: Steffen SCHLOTHAUER, Erdweg (DE); Frank STIEHLER, Bad Liebenwerda (DE); Alexander LADEWIG, Bad Wiessee (DE); Christian LIEBL, Bockhorn (DE); Johannes CASPER, Muenchen (DE); Juergen KRAUS, Dachau (DE); Johannes JAKIMOV, Fahrenzhausen (DE)

(21) Appl. No.: 15/911,380

(22) Filed: Mar. 5, 2018

(30) Foreign Application Priority Data
Mar. 13, 2017 (EP) 17160464.8

(51) Int. Cl. F01D 11/12

(52) U.S. Cl. CPC F01D 11/125; F05D 2220/323; F05D 2230/31; F05D 2260/30; F05D 2240/55

(57) ABSTRACT

A seal carrier (63) for a turbomachine (60) which is assembled from seal carrier segments, is provided. The seal carrier segments each have a seal structure (1a, b) on the radially inward side. These seal structures (1a, b) are either interleaved in the circumferential direction (4) such that a cross-sectional plane containing the longitudinal axis (2) of the turbomachine (60) intersects both the first seal structure (1a) and the second seal structure (1b), or the seal structures (1a, b) rest against each another.

The present invention relates to a seal carrier for a turbomachine.

### BACKGROUND

As will be described in detail below, the turbomachine may preferably be a jet engine. One component thereof is a so-called “seal carrier,” which surrounds the hot gas duct radially outwardly in the region of a rotor blade ring. Such as seal carrier includes a first and a second seal carrier segment, which are assembled in succession with respect to the circumference about a longitudinal axis of the turbomachine. At the radially inward side, the first seal carrier segment has a first seal structure, and the second seal carrier segment has a second seal structure.

### SUMMARY OF THE INVENTION

The present invention addresses the technical problem of providing a particularly advantageous seal carrier for a turbomachine.

This object is achieved in accordance with the present invention, on the one hand, by a seal carrier, where the first and second seal structures are interleaved with one another with respect to circumference about the longitudinal axis such that a cross-sectional plane containing the longitudinal axis of the turbomachine intersects both the first and second seal structures and, on the other hand, by a seal carrier, where the first and second seal structures rest against each another.

Preferred embodiments will be apparent from the present description and the dependent claims. In the description of the features, a distinction is not always drawn specifically between apparatus, device and use aspects. In any case, the disclosure should be read to imply all claim categories. In particular, all details given for a seal carrier should be read to apply also to a turbomachine, in particular a jet engine, having such as seal carrier.

Both approaches, namely the “interleaving” of the seal structures according to claim 1 and their “resting against” each other according to claim 9, are based on the same inventive idea, namely to lengthen or block the flow path between the sealing structures. By increasing the flow resistance, it is possible to improve the sealing effect, and thus to achieve higher efficiency. However, if, unlike the subject matter according to the present invention, seal carrier segments are assembled in accordance with the prior art, generally a separating joint having a width of between 0.3 and 0.4 mm exists circumferentially between the seal structures (taken in the circumferential direction), the separating joint extending axially continuously along a straight line. This results in leakages and efficiency losses.

In accordance with the present invention, this is avoided by the seal structures being interleaved with one another or resting against each other, the latter at least in the hot state, and preferably already in the cold state. Compared to a separating joint extending axially continuously along a straight line, the flow path is thereby at least lengthened. The “cross-sectional plane” specified in claim 1, which contains the longitudinal axis of the turbomachine (hereinafter also referred to as “turbomachine longitudinal axis”) and thus extends axially and radially, intersects both the first and second seal structures because of the interleaved arrangement thereof. Typically, this then applies to all cross-sectional planes that contain the turbomachine longitudinal axis and lie within a certain circumferential angular range which may span, for example, at least 0.01°, 0.03° or 0.05°, and (regardless thereof), for example, no more than 1°, 0.8° or 0.5° (with increasing preference in the order of mention). In comparison, in the case of an axially straight separating joint, there is not a single such cross-sectional plane that would intersect both of the seal structures at the same time. Rather, such cross-sectional planes intersect either one or the other of the seal structures or lie therebetween.

Each of the first and second seal carrier segments may preferably be a half-shell. Then, preferably, there is not only one flow-optimized transition due to the interleaving or resting against each other of the seal structures, but rather the second transition between the seal structures of the half-shells is also optimized, preferably analogously to the first one (i.e., both transitions are then optimized either by the interleaving or resting against each other of the seal structures). In very general terms, in the seal carrier, preferably all transitions between circumferentially successive seal structures belonging to different seal carrier segments are flow-optimized in accordance with the present invention.

Generally, in the context of the present disclosures, “a” and “an” are to be read as indefinite articles; i.e., in each case also as “at least one,” unless expressly stated otherwise. Thus, as explained above, it is also possible that a plurality of cross-sectional planes may meet the criterion set forth in the main claim; i.e., that a plurality of transitions of the seal carrier may be flow-optimized correspondingly. The turbomachine may then, for example, have a plurality of correspondingly configured seal carriers.

The seal carrier is “assembled” from a plurality of seal carrier segments; i.e., the latter are each previously manufactured separately and then fitted together. Assembly can generally also be accomplished by material-to-material bonding, for example by welding or brazing, such as induction brazing. Preferably, a seal carrier may be one that is assembled from two seal carrier half-shells that are assembled together only in an interlocking and/or fictional manner. However, the seal carrier half-shells may themselves be composed of a plurality of seal carrier segments, preferably of three seal carrier segments, the seal carrier segments of each seal carrier half-shell being joined together by a material-to-material bond, in particular by brazing. In this case, both the transitions between the seal carrier half-shells and those in each of the half-shells are flow-optimized in accordance with the present invention. Preferably, the seal carrier segments are additively manufactured; i.e., by selectively solidifying an amorphous or shape-neutral material (see below for more details). Through additive manufacturing, the interleaving structures or contacting structures can be produced particularly efficiently.

In the following, first the variant “interleaving” will be described in detail.

In a preferred embodiment, a separating joint between the first and second seal structures extends in an angled path relative to the axial direction, at least in portions thereof, as viewed radially, looking at it approximately from the turbomachine longitudinal axis radially outwardly. In other words, the separating joint should not extend axially continuously along a straight line, but have, for example, a stepped shape having one or more steps, or also a curved shape; i.e., describe a curved line (in the sense of a continuously differentiable curve).

Regardless of the details, the angled shape relative to the axial direction at least in some portions; i.e., at least in one axial portion, increases the length of the flow path between the seal structures. “Angled” may mean an angle of 90°, in the case of a pure stepped shape, for example, also in combination with an otherwise axially parallel extent; on the other hand, any angle smaller than 90° is possible as well (considered is always the smallest angle with the axial direction), it being possible that the angle may vary along the axial extent of the separating joint. The separating joint may extend radially in an angled path relative to a radial direction, at least in portions thereof, but preferred is a separating joint that has a straight-line, purely radial extent along a radial direction.

In so far as reference is made to an “axial” disposition or an “axial direction” generally in the context of this disclosure, these terms are used relative to the turbomachine longitudinal axis. In the turbomachine, the “turbomachine longitudinal axis” is then, for example, an axis of rotation about which the rotor blade ring disposed within the seal carrier is rotatably mounted. The terms “radial” and “radial direction” are also used relative to the turbomachine longitudinal axis, referring to an orientation perpendicular thereto. The terms “circumference” and “circumferential direction” likewise refer thereto, namely to a circumference about the turbomachine longitudinal axis as an axis of rotation.

Generally, the seal structures preferably form a cavity structure having a plurality of cavities that are axially and circumferentially separated from each other by cavity walls. While the cavities are axially and circumferentially surrounded by the cavity walls and preferably also closed radially outwardly, they are open toward the turbomachine longitudinal axis; i.e., radially inwardly. The cavity structure may preferably be a honeycomb structure. In this case, the cavities bounded by the cavity walls are each hexagonal in shape, as viewed radially. However, this is generally not mandatory. In so far as reference is generally made to cavities which are “axially and circumferentially” separated from each other by the cavity walls and thus are spatially successive, this means that a portion of the cavities are axially spatially successive and another portion of the cavities are circumferentially spatially successive; depending on the shape and configuration, it being possible that some of the cavities are actually both axially and circumferentially spatially successive.

In a preferred embodiment regarding the separating joint that extends in an angled path, at least in portions thereof, the separating joint intersects at least one of the cavities. This at least one cavity is then formed by the first and second seal structures; i.e., the sealing structures at the separating joint are at least partially open toward each other (with respect to the circumferential direction).

In another preferred embodiment, the sealing structures at the separating joint are closed toward each other; i.e., the separating joint is circumferentially bordered at both sides by adjacent cavity walls of the two seal structures. In other words, the separating joint that extends in an angled path, at least in portions thereof, is embedded in the cavity structure in such a way that it extends between the cavities of the seal structures without intersecting any of the cavities. Thus, the separating joint originates from a cavity structure imagined to be uninterrupted between the seal structures and runs through the structure only along cavity walls.

In a preferred embodiment, the cavities are arranged regularly at least in the circumferential direction and also across and beyond the separating joint. Due to the “regular” arrangement, a particular sequence of differently shaped and/or arranged cavities may arise periodically; i.e., repeatedly, along the circumference. Preferably, exactly one cavity type (one shape) repeats itself along the circumference, and, more preferably, circumferentially in equidistant arrangement and equal orientation (the arrangement is rotationally symmetric with a particular order of symmetry). Preferably, the cavities are regularly arranged in the axial direction as well; i.e., particularly preferably, the same cavity type repeats itself in the axial direction in equidistant arrangement.

Preferably, the cavities each have a polygonal outer shape, more preferably a hexagonal shape (honeycomb shape), as viewed radially. In the case of the sealing structures that are closed toward each other at the separating joint, the separating joint may extend along two side edges at each honeycomb cell adjacent to the separating joint; i.e., it may describe a zigzag line.

In a preferred embodiment, the seal structures are interleaved with one another such that a cavity wall of the first seal structure extends into the second seal structure in the circumferential direction. This cavity wall of the first seal structure is then located axially between cavity walls of the second seal structure, but at the same time preferably also axially spaced apart therefrom. Preferably also, a cavity wall of the second seal structure extends into the first seal structure in the circumferential direction (and is located axially between cavity walls of the first seal structure). Further preferably, each seal structure has a plurality of cavity walls that extend correspondingly into the respective other seal structure in the circumferential direction. Particularly preferably, the corresponding cavity walls of the two seal structures alternate with one another in the axial direction; i.e., the cross-sectional plane is intersected alternately by a cavity wall of the first seal structure and a cavity wall of the second seal structure. Also, regardless of the details, the “extending thereinto in the circumferential direction” of the respective cavity wall does not necessarily imply an extension only in the circumferential direction, although this is preferred (as viewed looking radially thereat).

In a preferred embodiment, the cavity wall(s) extending into the respective other seal structure end(s) in the respective other seal structure at a distance from the respective cavity wall(s) thereof. Thus, despite the interleaved arrangement of the first and second seal structures, nevertheless a certain play remains between the cavity walls thereof. This may be advantageous with respect to sometimes great temperature differences that may occur between the OFF state and the operating state. Despite a relative displacement which may occur in response to the temperature differences, it is thereby possible to prevent distortions.

In a preferred embodiment, at the cross-sectional plane, a cavity wall of the first seal structure merges into a cavity wall of the second seal structure, so that the two cavity walls form an interlocking fit. This interlocking fit is intended to inhibit relative displacement with respect to the axial direction, in generally also with respect to only one of the axial directions, but preferably with respect to both opposite axial directions.

In a preferred embodiment, the cavity walls that merge into one another are assembled in a tongue-and-groove fashion; i.e., one of the cavity walls forms a groove at its end that faces in the circumferential direction, into which groove is inserted the other cavity wall with its at its end that faces in the circumferential direction. The groove base and the tongue may have their longitudinal extent substantially in a radial direction. Although the interlocking fit inhibits axial relative displacement, a certain play may still exist in the circumferential direction for the reasons described a few paragraphs above; i.e., the tongue does not necessarily have to reach down to the base of the groove, at least not in the cold state.

The contacting seal structures will be described in detail below.

In a preferred embodiment, the first seal structure has a spring element via which it rests against the second seal structure. The spring element forms a contact surface which, due to the spring property, is supported such that it is resiliently supported to be displaceable in the circumferential direction. This “being resiliently displaceably supported” goes beyond a material-inherent resilience, which is determined by the modulus of elasticity, and, more specifically, is assisted, for example, by a spring element geometry that is self-supporting, at least in portions or regions thereof. The spring element may be clip or bridge-shaped, as viewed radially. Preferably, the second seal structure also has a spring element forming a resiliently displaceably supported contact surface. In this case, the two seal structures rest against each other by their spring elements.

The provision of a resiliently supported contact surface may be of interest with respect to a certain displacement compensation (see also the foregoing remarks). Ideally, a seal carrier can be implemented where the seal structures rest against each other in both the cold and hot states, and, in fact, without any material-critical distortions.

In a preferred embodiment, the spring element is supported by a bearing portion in the remainder of the seal structure so as to be slidable therein, the displacement of the contact surface in the circumferential direction being partially converted into a linear displacement of the bearing portion. Generally, the opposite end of the spring element may be formed monolithically with the remainder of the seal structure, but preferably the spring element has another bearing portion that is also slidably supported in the remainder of the seal structure. Depending on the support point, this “being slidably supported” results in a relative movability (of the support point with respect to the remainder of the seal structure) with at least one directional component in the axial direction. It may be preferred that entire displacement path be oriented axially. Also, regardless of the details, such a seal structure including a spring element can be manufactured particularly advantageously using additive manufacturing. In this case, the bearing is built up, for example, using a sacrificial material in some regions, and the relative movability is then provided after removal of the sacrificial material.

In a preferred embodiment, which may be of interest both in the case of the “resting against each other” and in the case of the “interleaving with one another,” the seal carrier segments each have a carrier structure radially outside the respective seal structure. The seal carrier segments are connected to each other by their carrier structures, in particular in an interlocking and/or fictional manner, but are otherwise movable relative to one another in their seal structures. Reference is made to the above remarks on displacement compensation and the advantages thereof.

In a preferred embodiment, the first seal carrier segment is a first seal carrier half-shell and the second seal carrier segment is a second seal carrier half-shell (see also the remarks made at the outset). Preferably, each of the seal carrier half-shells extends circumferentially over 180°. In this case, the seal carrier is composed only of the two seal carrier half-shells with respect to the circumferential direction, and these are connected to each other an interlocking and/or fictional manner, preferably only interlocking and/or fictional manner. In other words, the two half-shells form the seal carrier along the entire circumference; i.e., apart from the half-shells, there are no other seal carrier segments.

As mentioned earlier, in a preferred embodiment, the seal carrier segments are each additively manufactured parts. Thus, in very general terms, the parts are built up, on the basis of a data model, from an amorphous or shape-neutral material, which is transformed into a dimensionally stable state in selected regions using, for example, physical and/or chemical processes, such as selective local melting. Accordingly, it is possible to produce a wide range of different geometries. For example, it is possible to integrally form a spring element into the seal structure, or to produce cavity walls projecting in the circumferential direction, which, upon assembly, extend into the other seal structure. A carrier structure which in this case is ideally built up together with the seal structure in the same process may, on the other hand, be optimized with respect to specific structural-mechanical requirements. Also, regardless of the details, it may be preferred that each of the seal carrier segments be built up from a powder bed; i.e., by selectively solidifying, layer-by-layer, a powder bed by corresponding selective irradiation, preferably by a laser beam.

As mentioned earlier, the present invention also relates to a turbomachine having a seal carrier as disclosed herein, in particular a jet engine.

### BRIEF DESCRIPTION OF THE DRAWINGS

The present invention will now be explained in more detail with reference to exemplary embodiments. The individual features may also be essential to the invention in other combinations within the scope of the dependent claims, and, as above, no distinction is specifically made between different claim categories.

In the drawing,

FIGS. 1a-c each show two seal structures of a seal carrier which are adjacent one another along a separating joint that extends in an angled path, at least in portions thereof, the two seal structures being open toward each other;

FIG. 2 shows two seal structures of a seal carrier which are adjacent one another along a separating joint that extends in an angled path relative to the axial direction, the two seal structures being closed toward each other;

FIG. 3 shows two seal structures of a seal carrier which have a cavity structure whose cavity walls alternately extend into the respective other seal structure;

FIG. 4 shows two seal structures of a seal carrier which have a cavity structure whose cavity walls merge into one another in an interlocking fashion at a separating joint between the seal structures;

FIGS. 5a, b show two seal structures of a seal carrier which rest against each other via spring elements;

FIG. 6 schematically shows a jet engine having a seal carrier.

### DETAILED DESCRIPTION

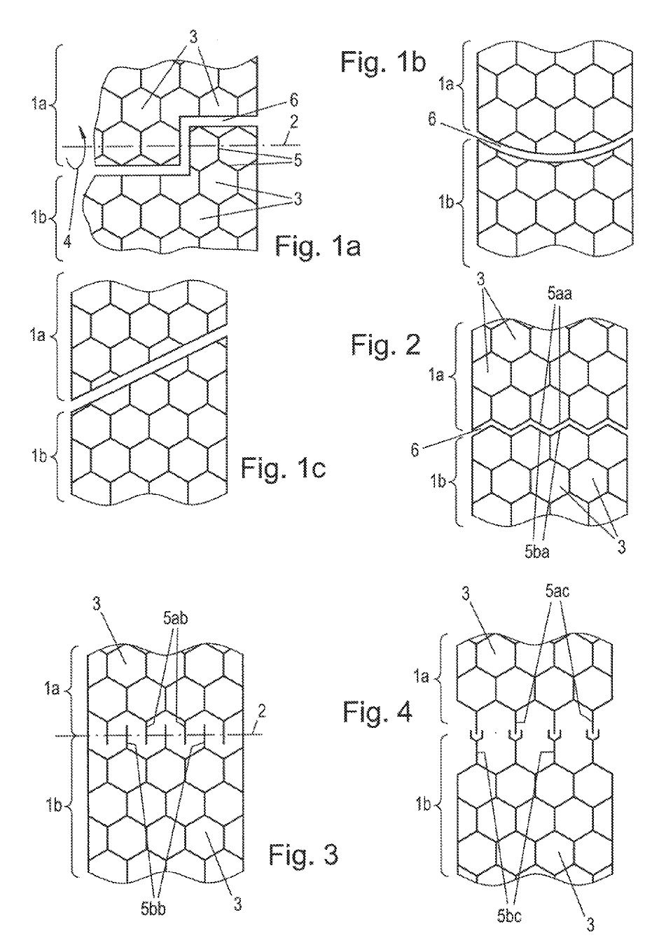

FIGS. 1a-c are views illustrating a first seal structure 1a and a second seal structure 1b, looking at them radially with respect to a turbomachine longitudinal axis 2.

Seal structures 1a, b each form part of a respective seal carrier half-shell (not shown in detail). The seal carrier half-shells are assembled to form a seal carrier. To this end, the seal carrier half-shells each have a carrier structure radially outside the respective seal structure 1a, b, the carrier structures connecting the half-shells together. The seal structures 1a, b shown in the figures form the radially inner portion of the seal carrier. Expressed more simply, the seal carrier as a whole is annular in shape and radially outwardly bounds the hot gas duct of a jet engine. In the jet engine, the seal carrier accommodates a rotor blade ring such that the radially outer tips of the rotor blades rub along seal structure 1 depicted in the figures, which is also referred to as abradable liner.

First seal structure 1a and second seal structure 1b form a cavity structure including a plurality of radially inwardly open, honeycomb-shaped cavities 3. Cavities 3 are separated from each other by the cavity walls 5 axially and in the circumferential direction 4.

A separating joint 6 extends between the first 1a and second 1b seal structures. In the case illustrated in FIGS. 1a-c, first seal structure 1a and second seal structure 1b are open toward each other at separating joint 6. Thus, separating joint 6 intersects some of cavities 3. The cavities 3 located at separating joint 6 are bounded by cavity walls 5 of both first seal structure 1a and second seal structure 1b. In other respects, FIGS. 1a-c differ in the shape of separating joint 6.

FIG. 1, for example, shows a separating joint 6 that has a step, but otherwise extends axially parallel to the turbomachine longitudinal axis. In contrast, the separating joint 6 shown in FIG. 1b has a curved shape along its entire axial extent, and the angle formed with the axial direction varies along the axial extent. The separating joint 6 of the embodiment shown in FIG. 1c does have a straight-line extent when considered alone, but, as a whole, is tilted with respect to the axial direction. Each of these embodiments is advantageous in that separating joint 6 is lengthened compared to a straight and solely axially parallel extent, which lengthens the flow path and increases the flow resistance correspondingly. In this way, the efficiency can be improved (see also the introductory part of this specification).

Improved efficiency is also achieved by the embodiment shown in FIG. 2, where separating joint 6 describes a zigzag line. In this case, unlike the embodiments shown in FIGS. 1a-c, first seal structure 1a and second seal structure 1b are closed toward each other at separating joint 6. Thus, separating joint 6 does not intersect any of the cavities 3. It is circumferentially bordered at both sides by adjacent cavity walls 5aa, 5ba of the respective seal structures 1a, b.

In the embodiment of FIG. 3, an increase in length of the flow path between seal structures 1a, b is achieved because cavity walls 5ab of first seal structure 1a extend into second seal structure 1b and cavity walls 5bb of second seal structure 1b extend into first seal structure 1a. Thus, the flow path is lengthened in a labyrinth-like manner.

In the embodiment shown in FIG. 4, cavity walls 5ac of first seal structure 1a merge in an interlocking fashion into cavity walls 5bc of second seal structure 1b. To this end, cavity walls 5ac, 5bc intermesh in a tongue-and-groove fashion, whereby a flow path between seal structures 1a, b can ideally be completely blocked.

In all embodiments described hereinbefore, first seal structure 1a and second seal structure 1b are interleaved with one another, and thus there is a cross-sectional plane containing the turbomachine longitudinal axis 2 (and extending both axially and radially) that intersects both first seal structure 1a and second seal structure 1b. In the illustrated embodiments, this cross-sectional plane would be oriented horizontally in the plane of the paper and perpendicularly thereto.

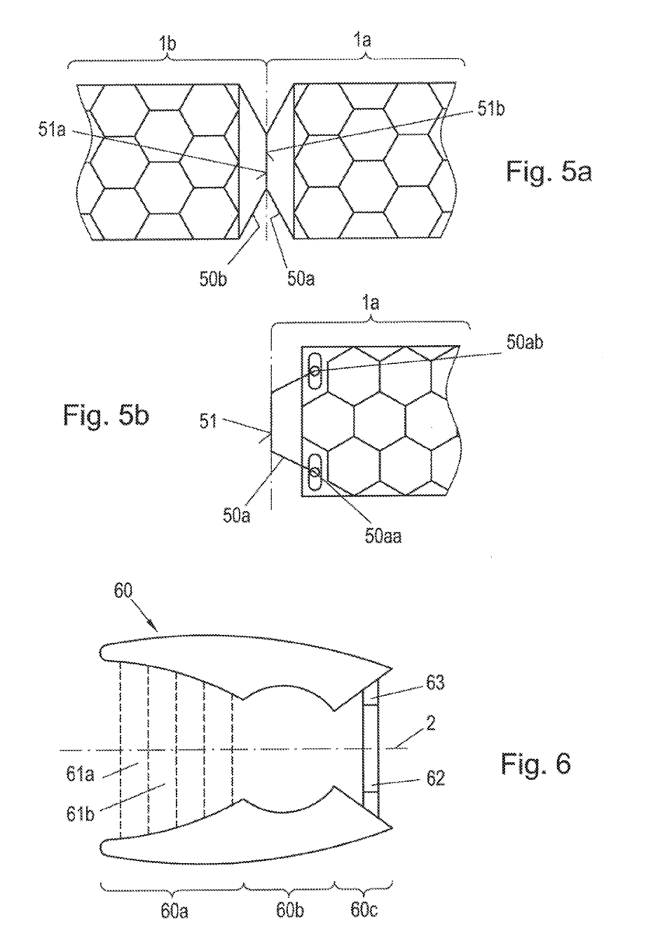

An increase in length and/or a blockage of the flow paths between seal structures 1a, b is also achieved with the embodiments shown in FIGS. 5a, b. In this case, however, the seal structures rest against each other, and each have a spring element 50a, b for this purpose. Spring elements 50a, b form respective contact surfaces 51a, b via which they rest against each other. Due to their resilient properties, contact surfaces 51a, b are somewhat resiliently supported to be displaceable in the circumferential direction, which allows for displacement compensation, for example, in the event of temperature variations.

In the exemplary embodiment shown in FIG. 5a, spring elements 50a, b are each connected at their axial ends to the remainder of the respective seal structures 1a, b, and designed to be self-supporting therebetween in order to assist the spring action. In the embodiment shown in FIG. 5b, spring element 50a is slidably supported in the remainder of the seal structure by two bearing portions 50aa, ab located at axially opposite ends. Thus, if contact surface 51 is displaced in circumferential direction 4, this displacement is partially converted into a linear displacement of bearing portions 50aa, ab.

FIG. 6 is a schematic cross-sectional view of a turbomachine 60, namely a jet engine, where the cross-sectional plane contains longitudinal axis 2 of turbomachine 60. The turbomachine is functionally divided into a compressor 60a, a combustor 60b and a turbine 60c. Compressor 60a includes a plurality of stages 61a, b in each of which a rotor blade ring follows a stator vane ring (not shown in detail). The turbine is also of multi-stage design, but for the sake of clarity, only one rotor blade ring 62 is shown. Rotor blade ring 62 is radially outwardly surrounded by a seal carrier 63 configured as described hereinabove. Thus, the rotor blades rub along seal the structure of seal carrier 63, which is not shown in detail in FIG. 6. The rotor blade rings of compressor 60a may also each be surrounded by a seal carrier according to the present invention, which is also not shown in detail.

### LIST OF REFERENCE NUMERALS

sealing structures 1a, b
longitudinal axis 2
cavities 3
circumferential direction 4
cavity walls 5
   laterally adjacent to the separating joint 5aa, ba
   extending into other seal structures 5ab, bb
   merging into one another 5ac, bc
separating joint 6
spring elements 50a, b
bearing portions 50aa, ab
contact surfaces 51a, b
turbomachine 60
   compressor 60a
   combustor 60b
   turbine 60c
compressor stages 61a, b
rotor blade ring, turbine 62
seal carrier 63

1-15. (canceled)

16. A seal carrier for a turbomachine, the seal carrier comprising:
a first and a second seal carrier segment assembled in succession with respect to a circumference about a longitudinal axis of the turbomachine;
the first seal carrier segment having a first seal structure and the second carrier segment having a second seal structure on radially inward sides with respect to the longitudinal axis of the turbomachine;
the first seal structure and the second seal structure being interleaved with one another with respect to the circumference such that a cross-sectional plane containing the longitudinal axis of the turbomachine intersects both the first seal structure and the second seal structure.

17. The seal carrier as recited in claim 16 wherein in a circumferential direction between the first seal structure and the second seal structure, a separating joint extends, the separating joint, when viewed in a radial direction, extending in an angled path relative to the axial direction, at least in portions thereof, along an axial extent.

18. The seal carrier as recited in claim 17 wherein the first seal structure and the second seal structure each form a cavity structure having a plurality of cavities axially and circumferentially separated from each other by cavity walls of the respective first and second seal structures, and wherein the separating joint intersects at least one of the cavities jointly formed by the first seal structure and the second seal structure at least partially open toward each other at the separating joint.

19. The seal carrier as recited in claim 17 wherein the first seal structure and the second seal structure each form a cavity structure having a plurality of cavities axially and circumferentially separated from each other by cavity walls of the respective first and second seal structures, and wherein the separating joint is completely bounded by adjacent cavity walls of the first and second seal structures closed toward each other at the separating joint.

20. The seal carrier as recited in claim 17 wherein the first seal structure and the second seal structure each form a cavity structure having a plurality of cavities axially and circumferentially separated from each other by cavity walls of the respective first and second seal structures, the cavities of the cavity structure being arranged regularly at least in the circumferential direction, and across and beyond the separating joint.

21. The seal carrier as recited in claim 16 wherein the first seal structure (1a) and the second seal structure each form a cavity structure having a plurality of cavities axially and circumferentially separated from each other by cavity walls of the respective first and second seal structures, and wherein, at the cross-sectional plane, a cavity wall of the first seal structure extends into the second seal structure in the circumferential direction so as to be located axially between cavity walls of the second seal structure.

22. The seal carrier as recited in claim 21 wherein the cavity wall of the first seal structure extending into the second seal structure ends in the second seal structure at a distance from the cavity walls of the second seal structure.

23. The seal carrier as recited in claim 16 wherein the first seal structure and the second seal structure each form a cavity structure having a plurality of cavities axially and circumferentially separated from each other by cavity walls of the respective first and second seal structures, and wherein, at the cross-sectional plane, a first cavity wall of the first seal structure merges into a second cavity wall of the second seal structure so that the first and second cavity walls form an interlocking fit.

24. The seal carrier as recited in claim 23 wherein the interlocking fit is formed by an intermeshing tongue-and-groove.

25. A seal carrier for a turbomachine, the seal carrier comprising:
a first and a second seal carrier segment assembled in succession with respect to a circumference about a longitudinal axis of the turbomachine;
the first seal carrier segment having a first seal structure and the second carrier segment having a second seal structure on radially inward sides with respect to the longitudinal axis of the turbomachine;
the first seal structure and the second seal structure resting against each other.

26. The seal carrier as recited in claim 15 wherein the first seal structure has a spring element and rests against the second seal structure via the spring element so that the spring element forms a contact surface resiliently supported to be displaceable in the circumferential direction.

27. The seal carrier as recited in claim 26 wherein a bearing portion of the spring element is slidably supported in a remainder of the first seal structure such that a resiliently supported displacement of the contact surface is partially converted into a linear displacement of the bearing portion.

28. The seal carrier as recited in claim 25 wherein, with respect to the longitudinal axis of the turbomachine, the first seal carrier segment has a first carrier structure radially outward of the first seal structure and the second seal carrier segment has a second carrier structure radially outward of the second seal structure, and wherein the first and second sea carrier segments are attached to each other by the first and second carrier structures, but are otherwise movable relative to one another in the respective first and second seal structures.

29. The seal carrier as recited in claim 25 wherein the first seal carrier segment is a first seal carrier half-shell and the second seal carrier segment is a second seal carrier half-shell, the two seal carrier half-shells jointly forming the seal carrier and being assembled together in an interlocking or fictional manner.

30. The seal carrier as recited in claim 25 wherein the first and second seal carrier segments are each additively manufactured parts.

31. A turbomachine comprising the seal carrier as recited in claim 25.

32. A jet engine comprising the turbomachine as recited in claim 31.

33. The seal carrier as recited in claim 16 wherein, with respect to the longitudinal axis of the turbomachine, the first seal carrier segment has a first carrier structure radially outward of the first seal structure and the second seal carrier segment has a second carrier structure radially outward of the second seal structure, and wherein the first and second sea carrier segments are attached to each other by the first and second carrier structures, but are otherwise movable relative to one another in the respective first and second seal structures.

34. The seal carrier as recited in claim 16 wherein the first seal carrier segment is a first seal carrier half-shell and the second seal carrier segment is a second seal carrier half-shell, the two seal carrier half-shells jointly forming the seal carrier and being assembled together in an interlocking or fictional manner.

35. The seal carrier as recited in claim 16 wherein the first and second seal carrier segments are each additively manufactured parts.

36. A turbomachine comprising the seal carrier as recited in claim 16.

37. A jet engine comprising the turbomachine as recited in claim 36.
